(19) United States
(12) Patent Application Publication
(10) Pub. No.: US 2024/0338817 A1
(43) Pub. Date: Oct. 10, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Kohtaro UMEZAWA, Tokyo (JP)

(21) Appl. No.: 18/613,201

(22) Filed: Mar. 22, 2024

(30) Foreign Application Priority Data
Apr. 6, 2023 (JP) 2023-062228

(51) Int. Cl. G06T 7/00; G06F 3/14; G06F 16/55; G06F 16/583; G06V 10/44; G06V 10/74

(52) U.S. Cl. CPC G06T 7/0012; G06F 3/14; G06F 16/55; G06F 16/583; G06V 10/44; G06V 10/761; G06T 2207/30068

(57) ABSTRACT

An information processing apparatus includes: a determination unit configured to determine whether or not a medical image is an image that is difficult to make a judgement about regarding a radiological interpretation item; a search unit configured to search for a similar medical image that is similar to the medical image and whose radiological interpretation item has a high degree of reliability, when the medical image is determined as an image that is difficult to make a judgement about; and a display control unit configured to display the similar medical image on a display unit.

### BACKGROUND OF THE INVENTION

### Field of the Invention

The technique disclosed herein relates to an information processing apparatus, an information processing method, and a storage medium.

### Description of the Related Art

There are known techniques for supporting doctors' diagnoses by performing a predetermined inference on a medical image obtained by a medical image capturing apparatus and presenting the inference result to the doctors. Japanese Patent Laid-Open No. 2021-185924 discloses a technique for assisting doctors' diagnosis by inferring and presenting the degree of difficulty in making a diagnosis with respect to medical images.

According to Japanese Patent Laid-Open No. 2021-185924, it is possible to present the degree of difficulty in making a diagnosis, but there is a problem in that it is impossible to present information that can reduce the degree of difficulty in making a diagnosis.

The technique disclosed herein provides a technique for presenting information to assist doctors in making a judgment regarding an image for which doctors are likely to have difficulty in making a judgment.

### SUMMARY OF THE INVENTION

According to one aspect of the present invention, there is provided an information processing apparatus comprising: a determination unit configured to determine whether or not a medical image is an image that is difficult to make a judgement about regarding a radiological interpretation item; a search unit configured to search for a similar medical image that is similar to the medical image and whose radiological interpretation item has a high degree of reliability, when the medical image is determined as an image that is difficult to make a judgement about; and a display control unit configured to display the similar medical image on a display unit.

According to another aspect of the present invention, there is provided an information processing apparatus comprising: a determination unit configured to determine whether or not a medical image is an image that is difficult to make a judgement about regarding a radiological interpretation item; a search unit configured to search for a similar medical image that is similar to the medical image, when the medical image is determined as an image that is difficult to make a judgement about; and a display control unit configured to display the similar medical image on a display unit.

According to still another aspect of the present invention, there is provided an information processing apparatus comprising: a determination unit configured to determine whether or not a medical image is an image that is difficult to make a judgement about regarding a radiological interpretation item; a search unit configured to search for a similar medical image that is similar to the medical image; and a display control unit configured to display the similar medical image on a display unit based on a result of the determination.

Further features of the present invention will become apparent from the following description of exemplary embodiments (with reference to the attached drawings).

### BRIEF DESCRIPTION OF THE DRAWINGS

FIG. 1 is a diagram showing a functional configuration of an information processing apparatus according to an embodiment.

FIG. 2 is a diagram showing a hardware configuration of the information processing apparatus according to the embodiment.

FIG. 3 is a flowchart showing display processing performed by the information processing apparatus according to the embodiment.

FIG. 4 is a diagram showing a functional configuration of an information processing apparatus according to a first modification of the embodiment.

FIG. 5 is a diagram showing an example display on a display device.

FIG. 6 is a diagram showing an example display on the display device.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

An information processing apparatus according to the present embodiment is applicable to a workstation connected to a medical image capturing apparatus, a workstation that performs image analysis, a radiological interpretation terminal viewer, and a function of searching for similar medical images using a workstation or a radiological interpretation terminal viewer. Here, examples of a medical image capturing apparatus include an X-ray mammography apparatus, an X-ray computed tomography (CT) apparatus, a magnetic resonance imaging (MRI) apparatus, a single photon emission computed tomography (SPECT) apparatus, a positron emission tomography (PET) apparatus, and so on.

### Embodiment

The present embodiment describes an information processing apparatus that assists doctors in making a judgment with respect to a breast composition based on an X-ray mammography image (medical image) obtained by capturing an object's breasts with an X-ray mammography apparatus. In the present embodiment, the medical image is an image obtained by capturing the mammary glands of an object, and the breast composition is a classification determined based on the amount of mammary gland tissue inside the breast, which is one of the following four categories in descending order of the amount of mammary gland tissue: “fatty”, “scattered”, “heterogeneous dense”, and “extremely dense”.

The Japan Central Organization on Quality Assurance of Breast Cancer Screening defines a method for making a judgment with respect to a breast composition based on a value (mammary gland density) obtained by dividing the area of a numerator region by the area of the denominator region, where the denominator region is the region where mammary gland tissue originally existed, and the numerator region is the region included in the denominator region and having a concentration higher than or equal to that of the pectoralis major muscle. Note that the following description is based on an example in which the medical image to be radiologically interpreted is an X-ray mammography image, and an example in which the radiological interpretation item to be radiologically interpreted is a breast composition, the medical image (target image) to be radiologically interpreted and the radiological interpretation item (target item) to be radiologically interpreted are not necessarily limited to these examples.

The information processing apparatus according to the present embodiment determines whether an X-ray mammography image (hereinafter also referred to as an “input image”) is an image that is (presumably) difficult for doctors to make a judgement with respect to a radiological interpretation item (a breast composition in the present embodiment) or an image that is (presumably) not difficult for doctors to make a judgement.

Upon determining that the image is difficult for doctors to make a judgement about, the information processing apparatus searches for an image whose attached information regarding the radiological interpretation item (breast composition) has a high degree of reliability and which is similar to the input image, from among X-ray mammography images (reference images) stored in a database such as an image server, and determines the image as a similar medical image that is similar to the input image. Thereafter, the information processing apparatus performs control to display the similar medical image found by the search and the information (identification information) regarding the radiological interpretation item (breast composition) attached to the similar medical image, on a display device 26 (a display unit). Note that the information (identification information) regarding the radiological interpretation item (breast composition) attached to each of the reference images is, for example, information (a category value) indicating the classification (category) of the breast composition that a doctor has given to the similar medical image, and information regarding the breast density.

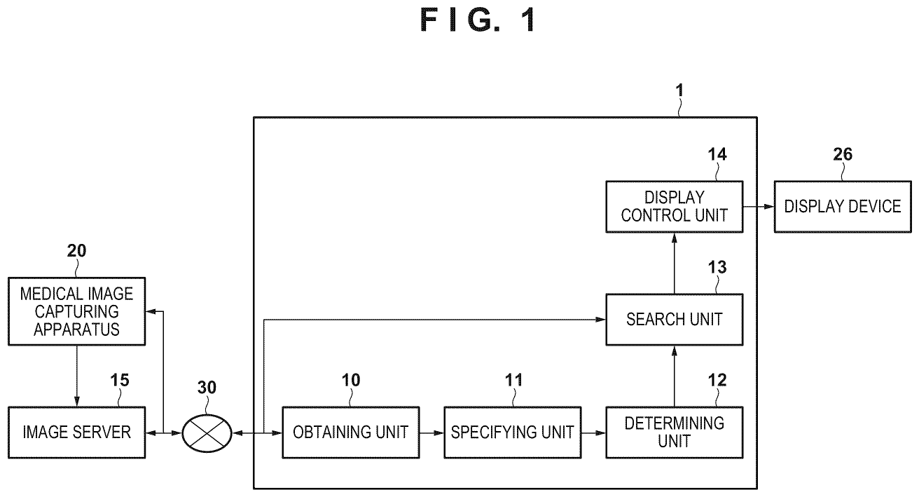

FIG. 1 is a diagram showing a functional configuration of the information processing apparatus according to the embodiment. An information processing apparatus 1 includes an obtaining unit 10, a specifying unit 11, a determining unit 12, a search unit 13, and a display control unit 14 as the components thereof.

The information processing apparatus 1 is connected to an external image server 15 and a medical image capturing apparatus 35 via a network 30. The image server 15 is a computer system (for example, a picture archiving and communication system (PACS)) that stores and shares images for image diagnosis, etc.

### Obtaining Unit 10

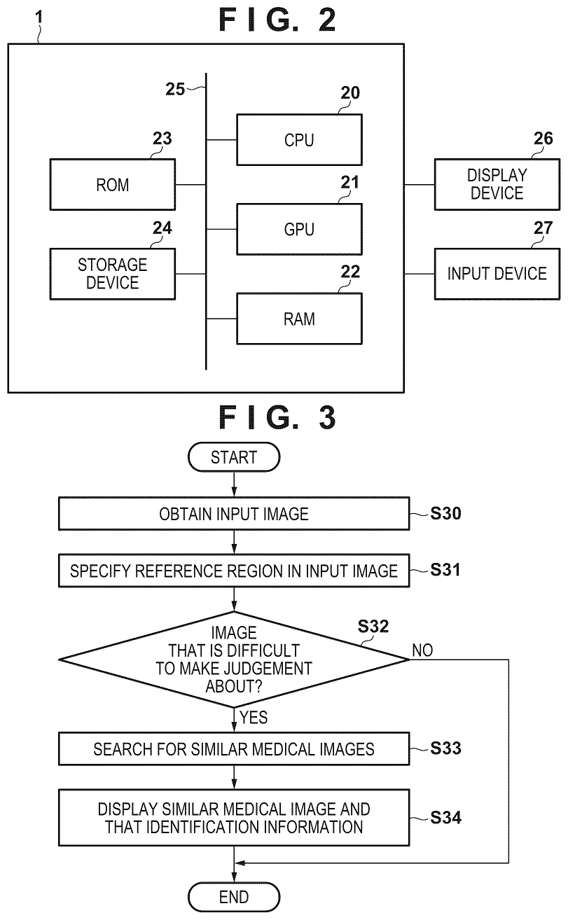

The obtaining unit 10 obtains and holds an X-ray mammography image of an object as an input image, and transmits the image to the specifying unit 11. The input image may be selected by an operator using the user interface (UI) of an input device 27 (FIG. 2) or the like from among images obtained from the medical image capturing apparatus 35 or the external image server 15. Alternatively, the obtaining unit 10 may obtain an image automatically transferred from the medical image capturing apparatus 35 or the external image server 15, as an input image. In the present embodiment, the image selected by the operator from among the images in the image server 15 is obtained as an input image.

### Specifying Unit 11

The specifying unit 11 specifies a reference region in the input image obtained by the obtaining unit 10, and transmits the result of the specification to the determining unit 12. The reference region may be specified through automatic extraction processing performed on the input image, or may be specified manually by the operator using the UI of the input device 27 or the like. For example, when the reference region is specified through automatic extraction processing, a rule-based method using image processing may be used for specification, or a segmentation method using machine learning or deep learning may be used for specification. When the reference region is specified manually using the UI, the operator may use the input device 27 such as a stylus pen to designate the region on the input image displayed on a display, which is an example of the display device 26. Note that the reference region in the present embodiment is the pectoralis major muscle region, and the specifying unit 11 specifies the pectoralis major muscle region in the input image as the reference region through a segmentation method using deep learning.

### Determining Unit 12

The determining unit 12 determines whether or not the input image obtained by the obtaining unit 10 is (presumably) difficult for doctors to make a judgement about with respect to a radiological interpretation item (breast composition). In the present embodiment, the determining unit 12 determines whether or not the image is difficult for doctors to make a judgement about, based on information regarding the reference region (pectoralis major muscle region) specified by the specifying unit 11. The determining unit 12 determines whether or not the image is difficult for doctors to make a judgement about, based on a comparison between information regarding the reference region and a predetermined value. For example, the determining unit 12 determines an image in which the size of the reference region (the pectoralis major muscle region) is smaller than a predetermined value as an image that is difficult for doctors to make a judgement about with respect to the breast composition. On the other hand, the determining unit 12 determine an image in which the size of the reference region is larger than or equal to the predetermined value as an image that is not difficult for doctors to make a judgement about with respect to the breast composition. When the image is determined as an image that is difficult for doctors to make a judgement about with respect to the breast composition, the determining unit 12 transmits the result of the determination to the search unit 13.

Here, information regarding the reference region, which is information indicating the size of the reference region, may be the number of pixels of the reference region, the area thereof, or the ratio of the reference region to the breast region or image region of a medical image capturing the object.

The predetermined value may be a value determined by the operator or a value obtained from known images. The value obtained from known images may be, for example, the minimum value of the reference regions of the medical images in the larger class resulting from clustering performed based on whether the size of the reference region of each medical image in the image server 15 is large or small. In the present embodiment, the size of the reference region is the number of pixels, and the predetermined value has been determined by the operator in advance.

### Search Unit 13

The search unit 13 searches for an image that is similar to the input image and whose attached information regarding the radiological interpretation item (breast composition) has a high degree of reliability from among the X-ray mammography images (reference images) stored in the database in the external image server 15 and to which identification information regarding the radiological interpretation item (breast composition) is added. Thereafter, the search unit 13 transmits the result of the search to the display control unit 14 as a similar medical image that is similar to the input image.

Here, any method for determining the similarity between images may be used to determine the similarity between each of the reference images group and the input image. For example, the search unit 13 may use the degree of similarity between the image features of the images. For example, image features such as statistic values of luminance values or texture features of images may be extracted in a plurality of dimensions, and thereafter the degree of similarity may be calculated based on the distance between the images in the extracted dimensional space. Alternatively, the determination may be performed through a classification method using machine learning or deep learning, or other known methods. At this time, to determine the similarity between images, the entire input image (medical image) may be used, or only the region outside the reference region obtained by excluding the reference region from the input image (medical image) may be used. The effect of limiting to the region outside the reference region is that the similarity between images can be determined regardless of the size of the reference region. In the present embodiment, image features such as statistic values of luminance values or texture features in the region outside the reference region are extracted in a plurality of dimensions, and the image (reference image) with the closest distance to the image in the extracted dimensional space is searched for as a candidate image for the similar medical image.

With respect to the degree of reliability of information regarding the radiological interpretation item (breast composition) attached to each of the reference images in the image server 15, the value of reliability determined in advance or information (for example, a flag) indicating that the degree of reliability is high may be held for each reference image as additional information of the reference image.

In this regard, the search unit 13 can determine the degree of reliability of each reference image based on the additional information and based on whether or not each reference image is an image that is difficult to make a judgement about with respect to the radiological interpretation item (breast composition). That is to say, if the reference image found by the search as a candidate image for the similar medical image is an image that is difficult to make a judgement about, the search unit 13 determines that “the degree of reliability is low”. If the reference image found by the search as a candidate image for the similar medical image is an image that is not difficult to make a judgement about, the search unit 13 determines that “the degree of reliability is high”. When the reference image is determined as an image that is not difficult to make a judgement about, the search unit 13 selects the reference image as a similar medical image whose radiological interpretation item has a high degree of reliability.

Whether or not the reference image is an image that is difficult to make a judgement about may be determined through determination processing that is similar to that performed by the determining unit 12. The search unit 13 determines whether or not the reference image is an image that is difficult to make a judgement about, based on a comparison between information regarding the reference region of the reference image found by the search as a candidate image for the similar medical image and a predetermined value. The search unit 13 determines whether or not the reference image is an image that is difficult to make a judgement about, based on whether or not information regarding the reference region in the reference image is smaller than the predetermined value. For example, the search unit 13 can determine a reference image in which the size of the reference region (pectoralis major muscle region) (for example, the number of pixels, the area, or the ratio of the reference region to the breast region or image region of the medical image) is larger than or equal to the predetermined value, as an image that is not difficult for doctors to make a judgement about with respect to the radiological interpretation item (breast composition). That is to say, the search unit 13 can determine the image as a reference image of a high degree of reliability. On the other hand, a reference image in which the size of the reference region (the pectoralis major muscle region) is smaller than a predetermined value is difficult for doctors to make a judgement about with respect to the radiological interpretation item (breast composition), and is determined as a reference image of low reliability. When the reference image found by the search as a candidate image for the similar medical image is determined as an image that is not difficult to make a judgement about, the search unit 13 selects the reference image as a similar medical image whose radiological interpretation item has a high degree of reliability.

### Display Control Unit 14

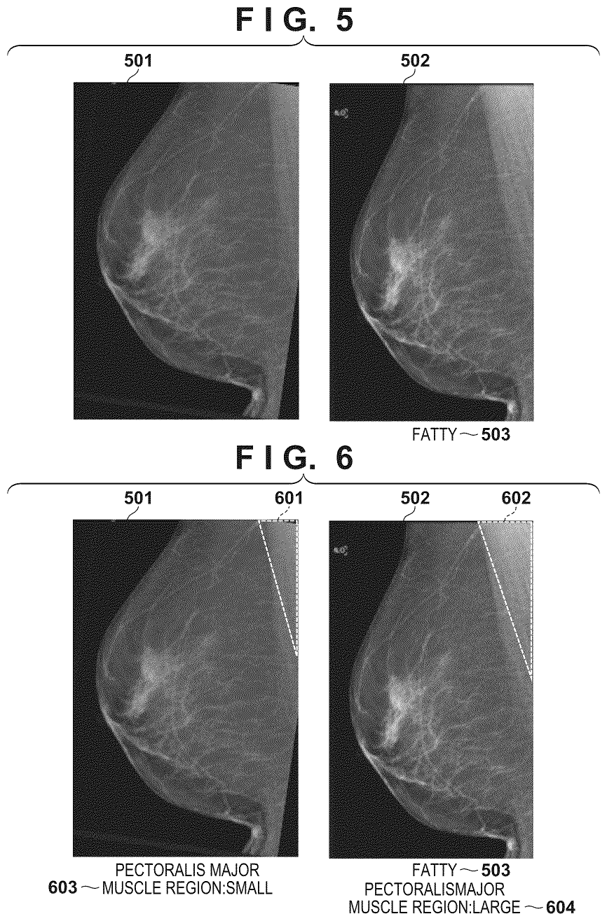

The display control unit 14 is capable of displaying on the display device 26 the input image, the similar medical image, which is the result of the search by the search unit 13, and identification information regarding the radiological interpretation (breast configuration) attached to the similar medical image. FIG. 5 is a diagram showing an example display on the display device 26 under the display control by the display control unit 14. In the example display in FIG. 5, the display control unit 14 displays a medical image 501, which is the input image, and a similar medical image 502, which has been found by the search unit 13, side by side within the screen of the display device 26. In the example display in FIG. 5, the display control unit 14 also displays identification information (“Fatty”) 503 regarding the radiological interpretation item (breast composition) near the similar medical image 502. Due to the medical image 501, which is the input image, and the similar medical image 502 displayed side by side within the screen and the identification information (“Fatty”) 503 displayed near the similar medical image 502, the doctor can view and compare the medical image 501 and the similar medical image 502. Thus, it is possible to assist the doctor in making a judgment with respect to the radiological interpretation. The display control by the display control unit 14 is not limited to that shown in the example display in FIG. 5, and only the similar medical image 502 found by the search unit 13 may be displayed. The display control unit 14 may display on the display device 26, information that specifies the object (patient information indicating the ID, the name, etc. of the patient) and information regarding the reference region in the medical image used by the determining unit 12 in determination processing (for example, the number of pixels, the area, the ratio of the reference region, and information indicating image features), together with the search result.

The display control unit 14 may display on the display device 26 the medical image, which is the input image used by the search unit 13 in search processing, and information regarding the reference region in the medical image (for example, the number of pixels, the area, the ratio of the reference region, and information indicating image features). When there is no similar medical image that meets the conditions, information indicating that there is no similar medical image may be displayed. The display device 26 may be a display attached to the information processing apparatus 1 or a portable information processing device (a mobile terminal) of a hospital personnel connected via an external server.

FIG. 6 is a diagram showing an example display on the display device 26 under the display control by the display control unit 14. In the example display in FIG. 6, the display control unit 14 displays a pectoralis major muscle region 601 in the medical image 501 and a pectoralis major muscle region 602 in the similar medical image 502, which are specified as reference regions. The display is not limited to the example display in FIG. 6, and the display control unit 14 may display information regarding the reference region in the pectoralis major muscle region 601 (for example, the number of pixels, the area, the ratio of the reference region, and information indicating image features) near the medical image 501. Alternatively, the display control unit 14 may display information regarding the reference region in the pectoralis major muscle region 602 (for example, the number of pixels, the area, the ratio of the reference region, and information indicating image features) near the similar medical image 502.

The search unit 13 may determine whether or not the medical image 501 and the similar medical image 502 are each an image that is difficult for doctors to make a judgement about with respect to the radiological interpretation item (breast composition), based on whether or not the information regarding the reference region is smaller than a predetermined value, and the display control unit 14 may display the result of the determination by the search unit 13.

In the example display in FIG. 6, a determination result 603 (pectoralis major muscle region: small) regarding the reference region in the medical image 501 indicates that the information regarding the reference region (pectoralis major muscle region 601) is smaller than the predetermined value and the medical image 501 is difficult for doctors to make a judgement about with respect to the radiological interpretation item (breast composition). A determination result 604 (pectoralis major muscle region: large) regarding the reference region in the similar medical image 502 indicates that the information regarding the reference region (pectoralis major muscle region 602) is larger than or equal to the predetermined value and the similar medical image 502 is a reliable image that is not difficult for doctors to make a judgement about with respect to the radiological interpretation item (breast composition).

By displaying the reference regions (the pectoralis major muscle region 601 and the pectoralis major muscle region 602) and the result of the determination based on the comparison between the information regarding the reference regions and the predetermined value, together with the medical image 501 and the similar medical image 502, it is possible to assist doctors in making a judgment with respect to the radiological interpretation.

### Hardware Configuration of Information Processing Apparatus 1

The information processing apparatus 1 is constituted by a computer that includes a processor, a memory, a storage, and so on. In this case, the program stored in the storage is loaded to the memory, the processor executes the program, and consequently the functions of the obtaining unit 10, the specifying unit 11, the determining unit 12, the search unit 13, the display control unit 14, and so on and the processing performed thereby are realized. However, the present invention is not limited to this configuration. For example, one or more or all of the obtaining unit 10, the specifying unit 11, the determining unit 12, the search unit 13, and the display control unit 14 may be implemented using a specially designed processor (such as an ASIC) or an FPGA. Alternatively, part of the computation processing may be executed by a processor such as a GPU or a DSP. Furthermore, the information processing apparatus 1 may be constituted by a single piece of hardware, or a plurality of pieces of hardware. For example, a plurality of computers may cooperate to realize the functions of the information processing apparatus 1 and the processing performed thereby, using cloud computing or distributed computing.

FIG. 2 is a diagram showing a hardware configuration of the information processing apparatus 1 according to the embodiment. In this example, the information processing apparatus 1 includes a CPU 20, a GPU 21, a RAM 22, a ROM 23, and a storage device 24, which are connected via a system bus 25. The display device 26 such as a display, and the input device 27 such as a mouse or a keyboard are connected to the information processing apparatus 1.

### Operation of Information Processing Apparatus 1

Next, the flow of the display processing performed by the information processing apparatus 1 will be described with reference to the flowchart in FIG. 3.

In step S30, the obtaining unit 10 obtains and holds an X-ray mammography image as an input image, and transmits the image to the specifying unit 11.

In step S31, the specifying unit 11 specifies a reference region in the input image, and transmits the result of the specification to the determining unit 12.

In step S32, the determining unit 12 determines whether or not the input image is difficult for doctors to make a judgement about with respect to the radiological interpretation item (breast composition), based on information regarding the specified reference region. If the size of the reference region is larger than or equal to a predetermined value, the determining unit 12 determines that the input image is not difficult for doctors to make a judgement about with respect to the breast composition (NO in step S32), and the determining unit 12 terminates processing.

On the other hand, if the size of the reference region is smaller than the predetermined value, the determining unit 12 determines that the input image is difficult for doctors to make a judgement about with respect to the breast composition, and transmits the result of the determination to the search unit 13 (YES in step S32).

In step S33, the search unit 13 searches for an image that is similar to the input image and whose attached information regarding the radiological interpretation item (breast composition) has a high degree of reliability from among the reference images in the image server 15. Thereafter, the search unit 13 transmits the result of the search to the display control unit 14 as a similar medical image that is similar to the input image.

In step S34, the display control unit 14 displays the input image, the similar medical image, and identification information regarding the radiological interpretation item (breast composition) attached to the similar medical image, on the display device 26.

With the information processing apparatus 1 according to the present embodiment, when doctors have difficulty in making a judgment with respect to a breast composition, it is possible to search for and display a similar medical image that has image features similar to those of the medical image in regions other than the reference region, and in which the captured reference area is larger than or equal to a predetermined value and the radiological interpretation item has a high degree of reliability. In this way, it is possible to present information to assist doctors in making a judgment with respect to cases for which doctors are likely to have difficulty in making a judgment.

In the information processing apparatus 1 according to the above-described embodiment, the determining unit 12 determines whether or not the medical image is an image that is difficult to make a judgement about with respect to the radiological interpretation item, and when the determining unit 12 determines that the medial image is an image that is difficult to make a judgement about, the search unit 13 searches for a similar medical image that is similar to the medical image and whose radiological interpretation item has a high degree of reliability. The display control unit 14 displays the similar medical image on the display device 26. Note that in the information processing apparatus 1, the determining unit 12 may determine whether or not the medical image is an image that is difficult to make a judgement about with respect to the radiological interpretation item, the search unit 13 may search for a similar medical image that is similar to the medical image, and the display control unit 14 may display the similar medical image found by the search unit 13 on the display device 26 based on the result of the determination by the determining unit 12. The search unit 13 may perform a similar case search regardless of the result of the determination by the determining unit 12, and when the medical image is an image that is difficult to make a judgement about with respect to the radiological interpretation item based on the result of the determination by the determining unit 12, the display control unit 14 display the similar medical image found by the search unit 13 on the display device 26.

### First Modification of Embodiment

The above embodiment describes the case where a medical image of an object in which the size of the reference region is smaller than a predetermined value is determined as an image that is difficult for doctors to make a judgement about, in the processing by the determining unit 12 in step S32. However, the determination by the determining unit 12 may be performed using another method that is not based on the reference region.

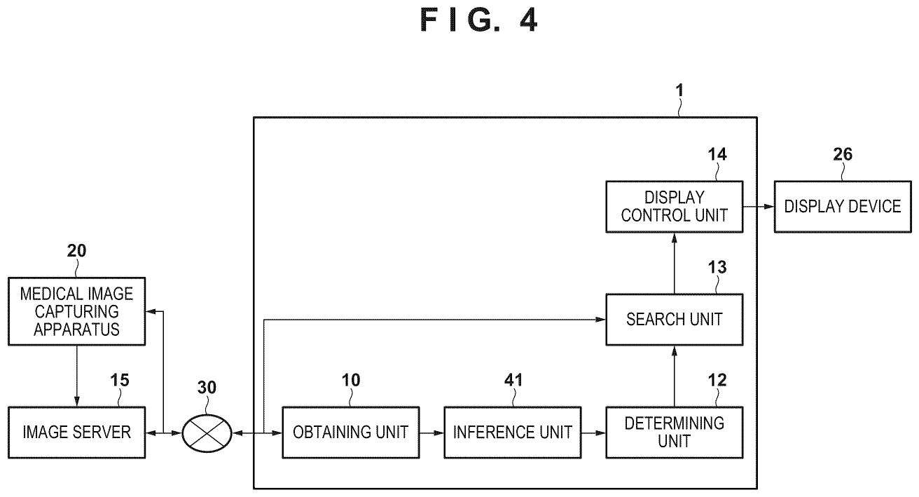

For example, the determination may be performed using a machine learning-based classifier (inference unit) to which an image is input and that outputs information indicating whether or not the image is difficult for doctors to make a judgement about. By preparing many pieces of training data to each of which a ground truth label indicating that the image is difficult for doctors to make a judgement about or that the image is not difficult for doctors to make a judgement about is attached, and training a predetermined known classifier (inference unit) that is based on deep learning or the like with the pieces of training data, it is possible to build a classifier (inference unit) that classifies images into images that are difficult for doctors to make a judgement about and images that are not difficult for doctors to make a judgement about. FIG. 4 is a diagram showing a functional configuration of the information processing apparatus 1 according to a first modification of the embodiment. The functional configuration of the information processing apparatus 1 in FIG. 4 is different from the functional configuration shown in FIG. 1 in that an inference unit 41 that has been trained based on machine learning is added thereto. The inference unit 41 outputs a classification result indicating whether or not the input medical image is difficult to make a judgement about with respect to the radiological interpretation item. The obtaining unit 10 inputs the obtained medical image to the inference unit 41, and the determining unit 12 determines, based on the classification result output from the inference unit 41, whether or not the medical image is an image that is difficult to make a judgement about with respect to the radiological interpretation item. If the medical image is classified as an image that is not difficult to make a judgement about with respect to the radiological interpretation item based on the result of the classification by the inference unit 41, the determining unit 12 terminates processing in the processing flow shown in FIG. 3 (NO in step S32). If the medical image is classified as an image that is difficult to make a judgement about with respect to the radiological interpretation item based on the result of the classification by the inference unit 41, the determining unit 12 transmits the result of the determination to the search unit 13 (YES in step S32).

The processing in step S33 is the same as the processing described in the embodiment, where the search unit 13 searches for an image that is similar to the input image and whose attached information regarding the radiological interpretation item (breast composition) has a high degree of reliability from among the reference images in the image server 15. The search unit 13 transmits the search result to the display control unit 14 as the similar medical image that is similar to the input image, and in step S34, the display control unit 14 displays the input image, the similar medical image, and the identification information regarding the radiological interpretation item (breast composition) attached to the similar medical image, on the display device 26.

### Second Modification of Embodiment

The above embodiment describes the case where a medical image of an object in which the size of the reference region is smaller than a predetermined value is determined as an image that is difficult for doctors to make a judgement about, in the processing by the determining unit 12 in step S32. However, the determination by the determining unit 12 may be performed using another method that is based on the reference region.

As a method other than that using the size of the reference region, the determination may be performed based on other information obtained using the reference region, for example. For example, as information regarding the reference region, image features of the reference region such as clarity may be used for the determination (based on whether or not the information indicating the image feature regarding clarity satisfies predetermined reference information).

If information indicating the image feature of the reference region satisfies predetermined reference information, the determining unit 12 determines that the input image is an image that is not difficult for doctors to make a judgement about with respect to breast composition. If information indicating the image feature of the reference region satisfies predetermined reference information, the determining unit 12 determines that the input image is an image that is not difficult for doctors to make a judgement about with respect to breast composition. Here, as information indicating the image feature regarding clarity, the strength of an edge near the outline of the reference region or the maximum luminance value within the reference region may be used, for example.

### Third Modification of Embodiment

The above embodiment describes the case where the medical image of the object is an X-ray mammography image, the pectoralis major muscle is used as the reference region when a judgement is made about the breast composition as the radiological interpretation item, and whether or not the medical image is “an image that is difficult for doctors to make a judgement about with respect to the radiological interpretation item” is determined. The technique disclosed herein is not limited to the above embodiment, and the medical image of the object may be an image other than the X-ray mammography image, and the reference region may be a region other than the pectoralis major muscle region. For example, the following describes a case where the medical image of the object is a mammary gland ultrasound image, and when the echo level of a tumor mass is to be judged to be an image interpretation item, the determination is performed using a subcutaneous fat region as the reference region.

Generally, doctors judge whether the echo level of a tumor mass in a mammary gland ultrasound image is “hypoechoic” or “isoechoic” by comparing the echo level with that of the subcutaneous fat region in the same image. Therefore, in the case of an ultrasound image in which the subcutaneous fat region is not clearly depicted, it is difficult to judge whether the tumor is “hypoechoic” or “isoechoic”.

Therefore, in the present modification, the subcutaneous fat region in the image is used as the reference region to determine “whether or not the image is difficult for doctors to make a judgement about with respect to the radiological interpretation item”. In this case, the specifying unit 11 specifies the subcutaneous fat region in the input image, using an image processing method or a machine learning method, and the determining unit 12 determines whether or not the image is difficult for doctors to make a judgement about with respect to the radiological interpretation item, based on information regarding the reference region specified by the specifying unit 11.

As in the present modification, even when the search target is different, the search unit 13 searches for an image that is similar to the input image and whose attached information regarding the radiological interpretation item (the echo level of a tumor mass) has a high degree of reliability from among the mammary gland ultrasound images (reference images) to which identification information regarding the radiological interpretation item (the echo level of a tumor mass) is attached, stored in the external image server 15. Thereafter, the search unit 13 can transmit the result of the search to the display control unit 14 as a similar medical image of the input image. The display control unit 14 displays the input image, the similar medical image, and identification information regarding the radiological interpretation item (the echo level of the tumor mass) attached to the similar medical image, on the display device 26. In the present modification, as in the embodiment, it is possible to present information to assist doctors in making a judgment with respect to cases for which doctors are likely to have difficulty in making a judgment.

### Fourth Modification of Embodiment

The above embodiment describes the case where the determination method regarding whether or not the medical image of the diagnosis target object (the input image) is “an image that is difficult to make a judgement about regarding the radiological interpretation item” and the method for calculating the degrees of reliability of the reference images in the image server 15 (the determination method regarding whether or not the attached radiological interpretation item is reliable) are both based on whether or not the size of the reference region is larger than or equal to the predetermined value.

However, these determination methods may be based on different determination criteria between when the determining unit 12 performs the determination on the medical image of the object and when the search unit 13 performs the determination on each of the reference images. For example, the determination regarding whether or not the medical image of the object is “an image that is difficult for doctors to make a judgement about regarding the radiological interpretation item” may be performed with reference to the size of the reference region, and the calculation of the degree of reliability of the similar medical image may be performed based on whether or not an image feature of the reference region such as a luminance value is no lower than a threshold value, or based on another criterion (for example, the confidence level assigned to the image by the person who performed the radiological interpretation, the level of the person's expertise (years of experience and the number of times the person has performed radiological interpretations), the position of the person, and the number of people who have performed radiological interpretation on the image, etc.).

### Fifth Modification of Embodiment

In the processing in step S33 in the above embodiment, the search unit 13 searches for an image that is similar to the input image and whose attached information regarding the radiological interpretation item (breast composition) has a high degree of reliability. However, it is possible to employ a configuration in which an image of high similarity is given priority in the search. That is to say, it is possible to employ a configuration in which, when the images similar to the input image do not include an image of a high degree of reliability (but include an image of low reliability), the search unit 13 may select an image of low reliability as the similar medical image. Alternatively, it is possible to employ a configuration in which a plurality of similar images are selected as similar medical images regardless of reliability, and reliability information is presented together with each image.

### Sixth Modification of Embodiment

The above embodiment describes the case where the boundary values of the four classifications of the breast composition determination method published by the Japan Central Organization on Quality Assurance of Breast Cancer Screening are used as the boundary values of the four classifications of breast composition. The technique disclosed herein is not limited to the above case, and values specified by a doctor may be used as boundary values of the four classifications of breast configuration. For example, the boundary value between “fatty” and “scattered” may be 20%, the boundary value between “scattered” and “heterogeneous dense” may be 45%, and the boundary value between “heterogeneous dense” and “extremely dense” may be 90%. In addition, instead of the four classifications of breast composition, a classification method using other indicators or another number of classifications may be used. For example, the operator may use the classification method and the number of classifications set using the UI of the input device 27 or the like.

### Seventh Modification of Embodiment

The above embodiment describes the case where the similar medical image of a high degree of reliability is searched for from among the medical images stored in the database in the external image server 15 and to which identification information is attached. The technique disclosed herein is not limited to the above case, and only medical images of a high degree of reliability may be registered in the database. The search unit 13 may search the image server 15 that stores reference images whose radiological interpretation item has a high degree of reliability, for the similar medical image that is similar to the medical image. In such a case, it is possible to omit the reliability determination processing from the search processing by the search unit 13.

With the technique disclosed herein, it is possible to present information to assist doctors in making a judgment regarding an image for which doctors are likely to have difficulty in making a judgment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-062228, filed Apr. 6, 2023 which is hereby incorporated by reference herein in its entirety.

What is claimed is:

1. An information processing apparatus comprising:
a determination unit configured to determine whether or not a medical image is an image that is difficult to make a judgement about regarding a radiological interpretation item;
a search unit configured to search for a similar medical image that is similar to the medical image and whose radiological interpretation item has a high degree of reliability, when the medical image is determined as an image that is difficult to make a judgement about; and
a display control unit configured to display the similar medical image on a display unit.

2. The information processing apparatus according to claim 1,
wherein the display control unit displays, on the display unit, the medical image and identification information regarding the radiological interpretation item attached to the similar medical image, together with the similar medical image.

3. The information processing apparatus according to claim 1, further comprising:
a specifying unit configured to specify a reference region that is to be referenced at the determination, in the medical image,
wherein the determination unit determines whether or not the medical image is an image that is difficult to make a judgement about, based on a comparison between information regarding the reference region and a predetermined value, and
the search unit searches for the similar medical image when the determination unit determines that the medical image is an image that is difficult to make a judgement about.

4. The information processing apparatus according to claim 3,
wherein the determination unit determines that the medical image is an image that is difficult to make a judgement about when the information regarding the reference region indicates a value that is lower than the predetermined value, and
the search unit searches for the similar medical image when the determination unit determines that the medical image is an image that is difficult to make a judgement about.

5. The information processing apparatus according to claim 4,
wherein the information regarding the reference region includes information that indicates the number of pixels of the reference region, the area of the reference region, a ratio of the reference region to an image region of the medical image, or an image feature of the reference region.

6. The information processing apparatus according to claim 1, further comprising:
an inference unit configured to output a classification result regarding whether or not the input medical image is an image that is difficult to make a judgement about regarding the radiological interpretation item,
wherein the determination unit determines whether or not the medical image is an image that is difficult to make a judgement about regarding the radiological interpretation item, based on the classification result output from the inference unit.

7. The information processing apparatus according to claim 3,
wherein the search unit searches for a reference image that is similar to the medical image from among reference images in an image server, as a candidate image for the similar medical image,
whether or not the medical image is an image that is difficult to make a judgement about is determined based on a comparison between information regarding the reference region in the reference image and the predetermined value, and
when the medical image is determined as an image that is not difficult to make a judgement about, the reference image is selected as the similar medical image whose radiological interpretation item has a high degree of reliability.

8. The information processing apparatus according to claim 7,
wherein the search unit uses an image feature of the entire medical image or an image feature of a region of the medical image other than the reference region to search for the reference image that is similar to the medical image.

9. The information processing apparatus according to claim 7,
wherein the search unit determines that the reference image is an image that is not difficult to make a judgement about when the information regarding the reference region is determined to indicate a value that is higher than or equal to the predetermined value, and selects the reference image as the similar medical image whose radiological interpretation item has a high degree of reliability.

10. The information processing apparatus according to claim 9,
wherein the information regarding the reference region in the reference image includes information that indicates the number of pixels of the reference region, the area of the reference region, a ratio of the reference region to an image region of the medical image, or an image feature of the reference region.

11. The information processing apparatus according to claim 7,
wherein additional information is added to each reference image included in the reference images, the additional information indicating a high degree of reliability determined in advance, and
the search unit determines whether or not the reference image is an image that is difficult to make a judgement about, based on the additional information.

12. The information processing apparatus according to claim 7,
wherein the display control unit displays, on the display unit, information regarding the reference region in the medical image and information regarding the reference region in the similar medical image.

13. The information processing apparatus according to claim 1,
wherein the medical image is an image obtained by capturing mammary glands of an object, and
the radiological interpretation item is a classification based on a mammary gland density of the object.

14. The information processing apparatus according to claim 13,
wherein identification information regarding the radiological interpretation item includes information indicating the classification or information regarding the mammary gland density.

15. An information processing apparatus comprising:
a determination unit configured to determine whether or not a medical image is an image that is difficult to make a judgement about regarding a radiological interpretation item;
a search unit configured to search for a similar medical image that is similar to the medical image, when the medical image is determined as an image that is difficult to make a judgement about; and
a display control unit configured to display the similar medical image on a display unit.

16. The information processing apparatus according to claim 15,
wherein the search unit searches an image server that stores reference images whose radiological interpretation item has a high degree of reliability, for the similar medical image that is similar to the medical image.

17. An information processing apparatus comprising:
a determination unit configured to determine whether or not a medical image is an image that is difficult to make a judgement about regarding a radiological interpretation item;
a search unit configured to search for a similar medical image that is similar to the medical image; and
a display control unit configured to display the similar medical image on a display unit based on a result of the determination.

18. An information processing method comprising:
determining whether or not a medical image is an image that is difficult to make a judgement about regarding a radiological interpretation item;
searching for a similar medical image that is similar to the medical image and whose radiological interpretation item has a high degree of reliability, when the medical image is determined as an image that is difficult to make a judgement about; and
displaying the similar medical image on a display unit.

19. An information processing method comprising:
determining whether or not a medical image is an image that is difficult to make a judgement about regarding a radiological interpretation item;
searching for a similar medical image that is similar to the medical image when the medical image is determined as an image that is difficult to make a judgement about; and
displaying the similar medical image on a display unit.

20. A non-transitory computer-readable storage medium storing a program for causing a computer to execute the method according to claim 18.
